(19) United States
(12) Patent Application Publication
(10) Pub. No.: US 2025/0106813 A1
(43) Pub. Date: Mar. 27, 2025

(54) DYNAMIC CONFIGURATION OF MEASUREMENT PARAMETERS FOR SIDELINK POSITIONING

(71) Applicant: Nokia Technologies Oy, Espoo (FI)

(72) Inventors: Deepa MALAPATI RAVINDRAIAH, Bangalore (IN); Akshay JAISWAL, Bangalore (IN); Prajwal KESHAVAMURTHY, Munich (DE); Jürgen HOFMANN, Munich (DE); Gilsoo LEE, Naperville, IL (US)

(21) Appl. No.: 18/822,961

(22) Filed: Sep. 3, 2024

(30) Foreign Application Priority Data
Sep. 27, 2023 (IN) 202341065018

(51) Int. Cl. H04W 64/00; H04W 24/10; H04W 92/18

(52) U.S. Cl. CPC H04W 64/006; H04W 24/10; H04W 92/18

(57) ABSTRACT

Embodiments of the present disclosure relate to apparatuses, methods, and computer readable storage media for dynamic configuration of measurement parameters for sidelink positioning. In the method, a first apparatus receives, from a second apparatus, a plurality of measurement configurations for sidelink positioning. Moreover, in accordance with a determination that a first trigger condition defined the plurality of measurement configurations is met, the first apparatus determines a first measurement configuration corresponding to the first trigger condition from the plurality of measurement configurations. Thereby, the proposed solutions can advantageously improve the positioning accuracy.

### CROSS-REFERENCE TO RELATED APPLICATION

The present application claims priority to, and the benefit of, India Provisional Application No. 202341065018, filed Sep. 27, 2023, the contents of which are hereby incorporated by reference in their entirety.

### FIELDS

Various example embodiments of the present disclosure generally relate to the field of telecommunication and in particular, to methods, devices, apparatuses and computer readable storage medium for dynamic configuration of measurement parameters for sidelink (SL) positioning.

### BACKGROUND

Location-awareness is a fundamental aspect of wireless communication networks and will enable a myriad of location-enabled services in different applications. Location information may be obtained by various positioning technologies.

SL positioning is one of the positioning technologies, which is based on the transmissions of SL positioning reference signal (SL-PRS) between an anchor and a target user equipment (UE) to enable localization of the target UE within precise latency and accuracy requirements of the corresponding SL positioning session. In an SL positioning scenario, a target UE may perform a SL positioning process, for example, by exchanging SL-PRS with one or more anchor UEs to determine its location. In some situations, a target UE may perform self-positioning to localize itself based on PRS signal(s) from neighboring anchor UEs.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a plurality of measurement configurations for sidelink positioning; and in accordance with a determination that a first trigger condition defined the plurality of measurement configurations is met, determine a first measurement configuration corresponding to the first trigger condition from the plurality of measurement configurations.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a plurality of measurement configurations of measurement parameters for sidelink positioning; and receive, from the first apparatus, an indication of a first measurement configuration, the first measurement configuration being determined from a plurality of measurement configurations for sidelink positioning in response to that a first trigger condition is met, wherein the first trigger condition corresponds to the first measurement configuration and is defined in the plurality of measurement configurations.

In a third aspect of the present disclosure, there is provided a third apparatus. The third apparatus comprises at least one processor; and at least one memory storing instructions that, when executed by the at least one processor, cause the third apparatus at least to: receive, from a second apparatus, an indication of a first measurement configuration, the first measurement configuration being determined from a plurality of measurement configurations for sidelink positioning of a first apparatus in response to that a first trigger condition is met, wherein the first trigger condition corresponds to the first measurement configuration and is defined in the plurality of measurement configurations; and transmit, to the second apparatus, information indicating whether the first measurement configuration is accepted to be used.

In a fourth aspect of the present disclosure, there is provided a method. The method comprises: receiving, from a second apparatus, a plurality of measurement configurations for sidelink positioning; and in accordance with a determination that a first trigger condition defined the plurality of measurement configurations is met, determining a first measurement configuration corresponding to the first trigger condition from the plurality of measurement configurations.

In a fifth aspect of the present disclosure, there is provided a method. The method comprises: transmitting, to a first apparatus, a plurality of measurement configurations of measurement parameters for sidelink positioning; and receiving, from the first apparatus, an indication of a first measurement configuration, the first measurement configuration being determined from a plurality of measurement configurations for sidelink positioning in response to that a first trigger condition is met, wherein the first trigger condition corresponds to the first measurement configuration and is defined in the plurality of measurement configurations.

In a sixth aspect of the present disclosure, there is provided a method. The method comprises: receiving, from a second apparatus, an indication of a first measurement configuration, the first measurement configuration being determined from a plurality of measurement configurations for sidelink positioning of a first apparatus in response to that a first trigger condition is met, wherein the first trigger condition corresponds to the first measurement configuration and is defined in the plurality of measurement configurations; and transmitting, to the second apparatus, information indicating whether the first measurement configuration is accepted to be used.

In a seventh aspect of the present disclosure, there is provided a first apparatus. The first apparatus comprises means for receiving, from a second apparatus, a plurality of measurement configurations for sidelink positioning; and means for in accordance with a determination that a first trigger condition defined the plurality of measurement configurations is met, determining a first measurement configuration corresponding to the first trigger condition from the plurality of measurement configurations.

In an eighth aspect of the present disclosure, there is provided a second apparatus. The second apparatus comprises means for transmitting, to a first apparatus, a plurality of measurement configurations of measurement parameters for sidelink positioning; and means for receiving, from the first apparatus, an indication of a first measurement configuration, the first measurement configuration being determined from a plurality of measurement configurations for sidelink positioning in response to that a first trigger condition is met, wherein the first trigger condition corresponds to the first measurement configuration and is defined in the plurality of measurement configurations.

In a ninth aspect of the present disclosure, there is provided a third apparatus. The third apparatus comprises means for receiving, from a second apparatus, an indication of a first measurement configuration, the first measurement configuration being determined from a plurality of measurement configurations for sidelink positioning of a first apparatus in response to that a first trigger condition is met, wherein the first trigger condition corresponds to the first measurement configuration and is defined in the plurality of measurement configurations; and means for transmitting, to the second apparatus, information indicating whether the first measurement configuration is accepted to be used.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A is a schematic diagram illustrating measurement gap pattern for radio resource management (RRM) measurements in RRC_CONNECTED state;

FIG. 2B illustrates an example SL positioning scenario;

FIG. 2C illustrates a further example SL positioning scenario;

FIG. 3 illustrates a signaling chart for configuration of measurement parameters for sidelink positioning according to some example embodiments of the present disclosure;

FIG. 4 is a schematic diagram illustrating a relationship between a positioning reference signal processing window (PPW) and a positioning reference signal processing window repetition period (PPWRP);

FIG. 5 is a schematic diagram illustrating an example positioning reference signal (PRS) configuration for a stationary target UE;

FIG. 6 a schematic diagram illustrating an example PRS configuration for a fast-moving target UE;

FIG. 7 illustrates a signaling chart for dynamic configuration of measurement parameters for sidelink positioning according to some example embodiments of the present disclosure;

FIG. 8 illustrates a flowchart of a method implemented at a first apparatus according to some example embodiments of the present disclosure;

FIG. 9 illustrates a flowchart of a method implemented at a second apparatus according to some example embodiments of the present disclosure;

FIG. 10 illustrates a flowchart of a method implemented at a third apparatus according to some example embodiments of the present disclosure;

FIG. 11 illustrates a simplified block diagram of a device that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

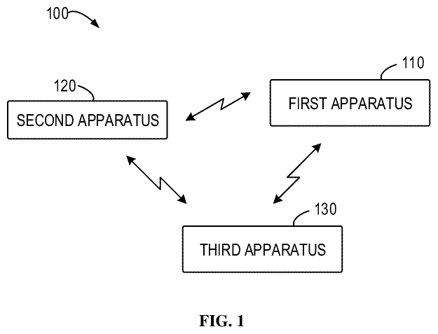

FIG. 1 illustrates an example communication environment 100 in which example embodiments of the present disclosure can be implemented. In the communication environment 100, there are a plurality of communication devices, for example, a first apparatus 110, a second apparatus 120, a third apparatus 130. Any two of these three apparatuses can communication with each other.

Sidelink (SL) positioning has been supported in new radio (NR) systems. SL positioning is based on the transmissions of sidelink positioning reference signal (SL PRS) by multiple anchor UEs. The SL-PRS is to be received by a target UE, e.g., in a SL time difference of arrival (TDOA) method. Alternatively, SL positioning is based on SL PRS exchange between the anchor and target UEs, e.g., in a SL round-trip time (RTT) method or in a multi-RTT method, so as to enable localization of the target UE and/or ranging of the target UE with respect to a reference UE (e.g., anchor UE) within precise latency and accuracy requirements of the corresponding SL positioning.

As used herein, the term “target UE” refers to a UE to be positioned (in this context, using SL, i.e., PC5 interface). In other words, a target UE is a UE for which the positioning measurement in question is performed. The term “anchor” or “anchor UE” refers to a UE supporting positioning of target UE, e.g., by transmitting and/or receiving reference signals for positioning, providing positioning-related information, etc., over the SL interface. The term “server UE” refers to a SL Positioning Server UE, which is a UE offering method determination, assistant data distribution and/or location calculation functionalities for Sidelink Positioning and Ranging based service. In one example, the serve UE may be a UE offering location server functionality in absence of LMF (i.e. when target UE is out of coverage), for sidelink positioning. The term “sidelink positioning” refers to that a positioning UE uses reference signals transmitted over SL, i.e., PC5 interface, to obtain absolute position, relative position, or ranging information. The term “ranging” refers to determination of the distance and/or the direction between a UE and another entity, e.g., anchor UE. The term “sidelink positioning reference signal (SL PRS or SL-PRS)” refers to a reference signal transmitted over SL for positioning purposes. Furthermore, the term “SL PRS (pre-)configuration” refers to (pre-)configured parameters of SL PRS such as time-frequency resources (other parameters are not precluded) including its bandwidth and periodicity.

In the following, for the purpose of illustration, some example embodiments are described with the first apparatus 110 operating as a target UE, the second apparatus 120 operating as a server UE or Location Management Function (LMF) device, and the third apparatus 130 operating as an anchor UE. However, it is to be understood that the above examples are just discussed for purpose of illustrations rather than limitations.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The present disclosure addresses an open problem in sidelink (SL) positioning in 5G New Radio (NR), in particular to reduce the adverse impact of mobility in SL positioning measurements.

Some existing Solutions for SL positioning target to support use cases such as vehicle-to-everything (V2X), public safety, commercial and industrial-internet-of-things (IIoT). A study on scenarios and requirements of in-coverage, partial coverage, and out-of-coverage NR positioning use cases with focus on V2X and public safety use cases has been conducted. Additionally, requirements for ranging-based services and positioning accuracy requirements for IIoT use cases in out-of-coverage scenarios haven been developed.

The performance requirements for different positioning service levels has been defined. It is noted that, along with horizontal and vertical accuracy requirements, the requirements on positioning service availability and positioning service latency are particularly very stringent for positioning service levels 4 (99.9% availability and 15 ms latency) and 6 (99.9% availability and 10 ms latency). The examples of scenarios/use cases of positioning service levels 4 and 6 include the following:
1) V2X, set-2 and set-3 use cases: This corresponds to lane level positioning requirement use cases such as vehicle platooning, cooperative lane merge, lane change warning, emergency break warning, intersection movement assist, etc., and below meter positioning requirement use cases, such as, high definition sensor sharing, vulnerable road user (VRU)—collision risk warning, cooperative maneuvers in emergency situations, real-time situation awareness and high-definition maps, etc.
2) IIoT: Factories of the Future scenarios such as augmented reality in smart factories, mobile control panels with safety functions in smart factories (within factory danger zones), inbound logistics for manufacturing (for driving trajectories, if supported by further sensors like camera, Global Navigation Satellite System (GNSS), Inertial Measurement Unit (IMU)) of indoor autonomous driving systems).

The UE measurement behavior when configured with Radio Resource Management (RRM) measurements will be described below. In a cellular network, RRM measurements are necessary to ensure UE stays connected to the best cell. Hence, as a minimum, the UE will continuously need to measure the serving cell and look for other neighbors while on the serving carrier. However, in most cases, the UE additionally has to search for and measure cells on other carriers than the serving.

This is done by network configuring the UEs with which carriers to measure and when to report the acquired measurement results to the network. UE will be performing those measurements and reporting according to the network configuration and UE shall follow the UE requirements related to how often and how long the UE should measure and when to report these measurements.

For some carriers these measurements may be impossible without measurement gaps (MG), wherein UE temporarily stops using the current serving carrier(s), tunes to the carrier to be measured and performs the measurements on the configured carrier(s) to be measured. Hence, the UE cannot receive data on the serving cell/carrier during the configured measurement gaps.

On some other carriers, the UE may be able to perform the measurements without gaps. However, performing such measurements may cause some interruptions to serving carriers in certain cases.

For robust network operation, the network needs to know which carriers the UE can measure without gaps and for which carriers the UE needs gaps to measure as network then needs to allocate gaps to the UE. Additionally, the network needs to know whether the UE causes interruptions on serving carriers during the measurements without gaps.

In the existing design, it have been considered defining the measurement period for the UE in Radio Resource Control (RRC) INACTIVE state based on the receiving information as a part of an on-demand PRS request from the UE as a length of time Nᵢ, defining a maximum duration of PRS that the UE can buffer assuming a maximum PRS bandwidth supported on a corresponding frequency band, or a length of time Tᵢ, defining a length of time required by the UE to process a PRS duration of Nᵢ, assuming the maximum PRS bandwidth supported on the corresponding frequency band.

For SL positioning it is agreed to support single component carrier, hence the measurement requirements without measurement gap apply. In one example, an SL PFL is not defined. SL positioning RS are defined directly with respect to and contained within a single SL bandwidth part (BWP) and carrier. However, the existing designs on gapless measurements have not considered the dynamic configuration related to the UE measurement behavior for sidelink positioning. Instead, the existing designs have considered defining the number of PRS measurements samples based on the PRS bandwidth and the magnitude of the difference between the serving cell's SS-RSRP or PRS-RSRP and the neighbor cell's PRS-RSRP. Similarly, the periodicity of the PRS reference signal time difference (RSTD) measurement in positioning frequency layer fails to capture the dynamic behavior posed by SL UE.

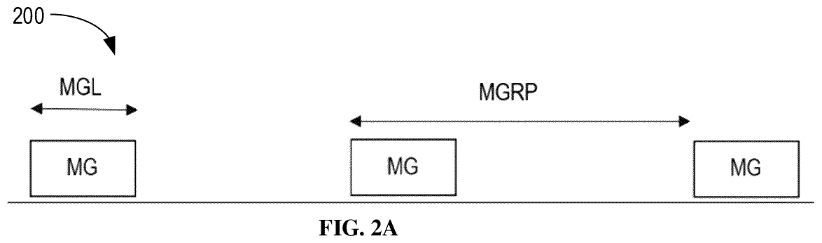

The UE measurement behavior in RRC_CONNECTED state, when RRM measurements are configured and the UE requires a measurement gap, is determined by a measurement gap pattern (MGP) with a measurement gap length (MGL) which is repeated with the periodicity of the measurement gap repetition period (MGRP). RRM measurements which require a measurement gap, are only performed within the measurement gap (MG) as depicted in FIG. 2A. FIG. 2A is a schematic diagram 200 illustrating measurement gap pattern for RRM measurements in RRC_CONNECTED state.

Considering the dynamic behavior of sidelink UE to perform the SL positioning, both anchor and target SL UE could be moving from one SL coverage area to another. FIG. 2B illustrates an example SL positioning scenario 201. In FIG. 2B, the vehicle 210 may represent the target SL UE, while the vehicles 220-1, 220-2, 220-3, 220-4 and 220-5 may represent a set of anchor SL UEs. As shown in FIG. 2B, since the SL UE has limited SL coverage area in comparison to Uu coverage area and hence the measurements requirement needs to be reconsidered for the SL positioning. Also, while performing the positioning measurement, the reference position of the measurement tends to change due to SL UE mobility. FIG. 2C illustrates a further example SL positioning scenario 202. As shown in FIG. 2C, the combined measurement from both snapshot 1 and snapshot 2 may lead to measurement error. In FIG. 2C, the vehicle 210 may represent the target SL UE, while the vehicles 220-1, 220-2, and 220-3 may represent a set of anchor SL UEs.

Target UE may be configured to perform the PRS measurement for positioning using one of the following methods depending upon the UE capability and LMF configuration:
1) PRS measurement during the measurement gaps: PRS measurement is performed during measurement gaps (may also be periodic).
2) PRS measurement without measurement gaps: PRS measurement is performed during the PRS processing window (may also be periodic).
3) On-Demand PRS: PRS transmission procedure can be initiated either by the UE or LMF when required. This procedure allows the LMF to control and decide whether PRS is transmitted or not and to change the characteristics of an ongoing PRS transmission.

By way of example, consider the target UE that is configured for PRS measurement without measurement gaps performs PRS measurements every 200 ms. If the target UE starts moving at a high speed, the positioning measurement accuracy will degrade due to one of the following reasons:
1) The SL PRS measurement is done every 200 ms which means the position co-ordinates will be updated every 200 ms and this may not be desirable in some use cases where the accurate position is required consistently to be updated very often. For example, V2X case with automated driving where accurate position should be frequently updated to avoid any collisions.
2) In case of SL PRS measurement, the anchor UEs (which may be stationary or mobile) may be reselected very often due to high speed of the target UE. This could lead to uncertainty in the positioning measurement and/or frequent dropping of the positioning measurements due to frequent anchor reselection.

If the measurement requirements are not addressed considering the dynamic behavior of SL UE it could lead to uncertainty in the positioning measurement, degradation of measurement accuracy and/or measurement overhead.

To overcome the described issues above, there is a need for dynamic configuration of PRS measurements to improve the positioning accuracy, reduction of the measurement errors or measurement overhead.

Several solutions are proposed herein to at least address the above-mentioned problem. A method for configuration of measurement parameters for sidelink positioning is proposed. In the method, one or more measurement parameters for sidelink positioning is dynamically modified at the target UE to perform sidelink positioning measurements. In some example embodiments, the measurement parameters may comprise a PRS Processing Window (PPW), i.e., time duration in which the PRS measurement is performed. Additionally or alternatively, the measurement parameters may comprise a PPW Repetition Period (PPWRP), i.e., time gap between the consecutive PRS measurements including PPW. In some further embodiments, the measurement parameters may comprise the minimum number of anchor UEs for PRS measurement. It should be understood that the above examples of measurement parameters are described merely for purpose of description. The scope of the present disclosure is not limited in this respect.

In aid of the dynamic configuration of the measurement parameters for sidelink positioning, the proposed solutions can advantageously improve the positioning accuracy and reduce the measurement errors and/or measurement overhead.

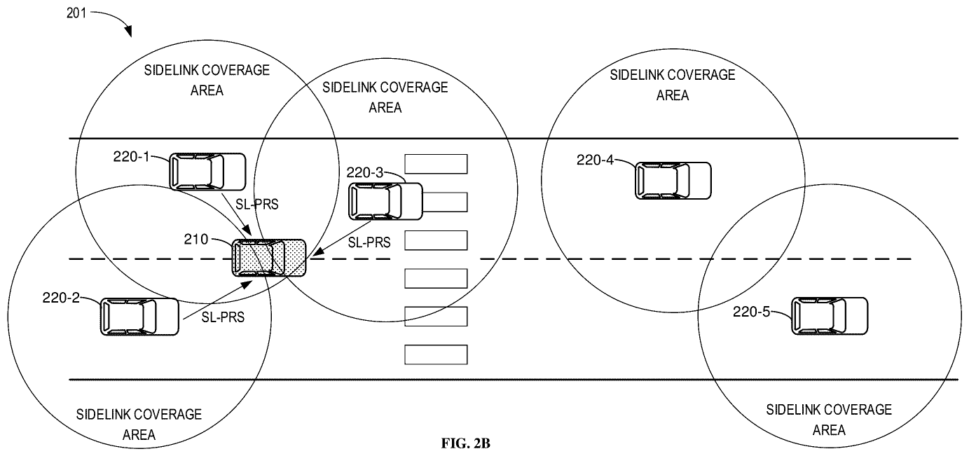

FIG. 3 illustrates a signaling chart 300 for configuration of measurement parameters for sidelink positioning according to some example embodiments of the present disclosure. For the purposes of discussion, the signaling chart 300 will be discussed with reference to FIG. 1, for example, by using the first apparatus 110, the second apparatus 120 and the third apparatus 130. In some example embodiments, the first apparatus 110 may comprise a terminal device acting as a target apparatus in a sidelink positioning process or session, the second apparatus 120 may comprise a terminal device or a network device (for example, an LMF device) acting as a server in the sidelink positioning process or session. Moreover, the third apparatus 130 may comprise a terminal device acting as an anchor apparatus in the sidelink positioning process or session.

In the signaling chart 300, the second apparatus 120 transmits (310), to the first apparatus 110, a plurality of measurement configurations of measurement parameters for sidelink positioning. For example, each configuration of the plurality of measurement configurations may comprise a trigger condition which corresponds to at least one measurement parameter. Examples of measurement parameters comprise, but are not limited to, a Positioning Reference Signal Processing Window (PPW), a Positioning Reference Signal Processing Window Repetition Period (PPWRP), a minimum number of third apparatuses 130 which transmit sidelink reference signals for the sidelink positioning, and/or the like. By way of example rather than limitation, the plurality of measurement configurations may be implemented as a table or the like.

The first apparatus 110 receives (315) the plurality of measurement configurations from the second apparatus 120. In accordance with a determination that a first trigger condition defined the plurality of measurement configurations is met, the first apparatus 110 determines (320) a first measurement configuration corresponding to the first trigger condition from the plurality of measurement configurations.

In some example embodiments, the first apparatus 110 may determine whether the first trigger condition is met based on mobility information of the first apparatus 110. By way of example rather than limitation, the mobility information may comprise a velocity of the first apparatus 110, a relative velocity between the first apparatus 110 and a third apparatus 130 transmitting a sidelink reference signals for the sidelink positioning, and/or the like.

Additionally or alternatively, the first apparatus 110 may determine whether the first trigger condition is met based on signal strength information of received sidelink reference signals. In one example, the signal strength information may comprise signal strength of respective sidelink reference signals transmitted from the third apparatuses 130. In a further example, the signal strength information may comprise a first number of third apparatuses 130, each of which transmits a sidelink reference signal whose signal strength is above a first threshold strength. In a still further example, the signal strength information may comprise a second number of third apparatuses 130, each of which transmits a sidelink reference signal whose signal strength is below a second threshold strength. It should be understood that the above examples are described merely for purpose of description. The scope of the present disclosure is not limited in this respect.

It should be understood that the first apparatus 110 may also determine whether the first trigger condition is met based on any other suitable information, e.g., importance information of third apparatuses 130 transmitting the sidelink reference signals for the sidelink positioning, and/or the like. The scope of the present disclosure is not limited in this respect. By way of example rather than limitation, if it is determined that measurement of the sidelink reference signals is performed for a set of third apparatuses whose importance levels exceed an importance threshold, the first apparatus 110 may determine the first trigger condition is met.

The first apparatus 110 may transmit (325) an indication of the first measurement configuration to the second apparatus 120. By way of example rather than limitation, the indication may comprises a trigger ID corresponding to a trigger condition, which will be described in detail below with reference to Table 1.

The second apparatus 120 receives (330) the indication of the first measurement configuration from the first apparatus 110. In addition, the second apparatus 120 may determine whether the first apparatus 110 is able to support the first measurement configuration based on a data transmission requirement, an anchor reselection requirement, a mobility requirement, a signal strength requirement, an anchor importance requirement, and/or the like. If it is determined that the first apparatus 110 is unable to support the first measurement configuration, the second apparatus 120 may determine the first measurement configuration is rejected to be used. If it is determined that the first apparatus 110 is able to support the first measurement configuration, the second apparatus 120 may determine the first measurement configuration is accepted to be used.

The second apparatus 120 may transmit (335) the indication of the first measurement configuration to the third apparatus 130 which transmits a sidelink reference signal for the sidelink positioning. The third apparatus 130 receives (340) the indication of the first measurement configuration from the second apparatus 120, and transmits, to the second apparatus 120, information indicating whether the first measurement configuration is accepted to be used.

The second apparatus 120 receives (350), from the third apparatus 130, information indicating whether the first measurement configuration is accepted to be used. If the information indicates that the first measurement configuration is not accepted to be used, the second apparatus 120 may determine the first measurement configuration is rejected to be used. If the information indicates that the first measurement configuration is accepted to be used, the second apparatus 120 may determine the first measurement configuration is accepted to be used.

In some example embodiments, the second apparatus 120 may transmit, to the first apparatus 110, first information indicating whether the first measurement configuration is accepted to be used. The first apparatus 110 may receive the first indication from the second apparatus 120. If it is determined that the first information indicates that the first measurement configuration is accepted to be used, the first apparatus 110 may apply the first measurement configuration.

Alternatively, if it is determined that the first information indicates that the first measurement configuration is accepted to be used, the first apparatus 110 may transmit an indication of the first measurement configuration to the third apparatus 130. After receiving this indication of the first measurement configuration, the third apparatus 130 may transmit, to the first apparatus 110, second information indicating whether the first measurement configuration is accepted to be used. Moreover, if it is determined that the first measurement configuration is accepted to be used, the third apparatus 130 may transmit a sidelink reference signal for the sidelink positioning based on the first measurement configuration.

The first apparatus 110 may receive the second information from the third apparatus 130. If it is determined that the second information indicates that the first measurement configuration is accepted to be used, the first apparatus 110 may apply the first measurement configuration.

In view of the above, the proposed solutions can advantageously dynamically configurate the measurement parameters for sidelink positioning. Thereby, the positioning accuracy can be improved and the measurement errors and/or measurement overhead can be reduced or avoided.

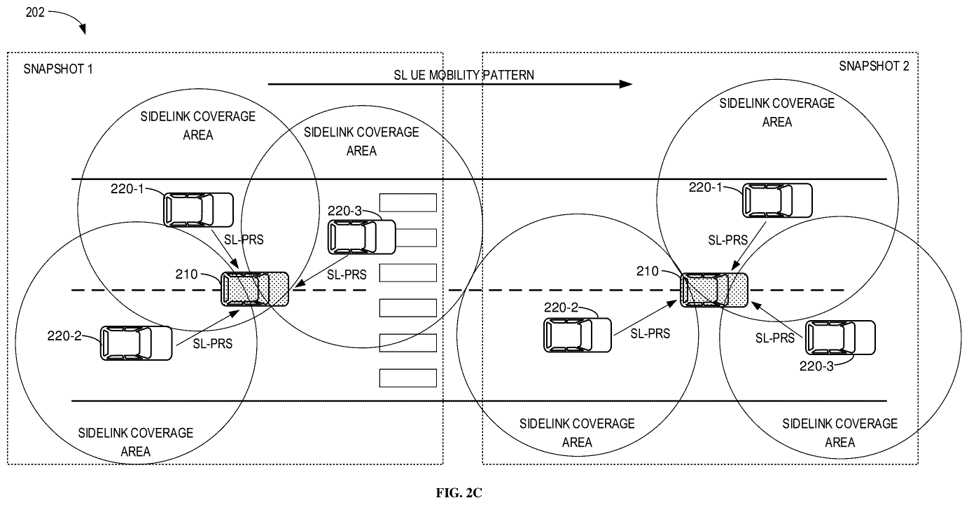

The solutions presented in FIG. 3 will be described in more details below with reference to FIGS. 4-7. FIG. 4 is a schematic diagram 400 illustrating a relationship between a PPW and a PPWRP. As shown in FIG. 4, the PPW represents a time duration in which the PRS measurement is performed, and the PPWRP represents a time gap between the consecutive PRS measurements including PPW.

The PPWRP and PPW values for different trigger conditions may be pre-configured by gNB/LMF. Several example trigger conditions for dynamic configuration of the measurement parameters are shown in Table 1. It should be understood that the specific values and trigger conditions listed in Table 1 are intended to be illustrative rather than limiting the scope of the present disclosure.

TABLE 1
Examples for dynamic configuration of measurement parameters

| | | PPW | PRS | Minimum |
|---|---|---|---|---|
| | | Repetition | Processing | number of |
| | | Period | Window | anchor UEs |
| Trigger | | PPWRP | PPW | for PRS |
| ID | Trigger condition | (in ms) | (in ms) | measurement |
| 1 | UE is stationary or | 200 | 10 | 4 |
| | has low speed | | | |
| 2 | UE | 40 | 10 | 4 |
| | speed > threshold ‘x’ | | | |
| 3 | PRS signal strength | 200 | 10 | 2 |
| | of ‘n’ anchor | | | |
| | UEs > threshold | | | |
| | ‘y’ with low speed | | | |
| 4 | PRS signal strength | 200 | 10 | 5 |
| | of ‘n’ anchor | | | |
| | UEs < threshold | | | |
| | ‘z’ with low speed | | | |
| 5 | PRS measurement | 200 | 10 | 3 |
| | performed for the | | | |
| | anchor UEs | | | |
| | configured with | | | |
| | high importance | | | |

In some example embodiments, if the velocity of the moving UE or relative velocity between the target and anchor UEs is below a speed threshold, which corresponds to the trigger condition 1 in Table 1, the target UE may apply the PPW/PPWRP values provided in the Table 1 for the corresponding trigger condition 1 after receiving acknowledgement from network. By way of example, the speed threshold may be preconfigured by gNB/LMF. Alternatively or additionally, if the velocity of the moving UE or relative velocity between the target and anchor UEs is above a speed threshold, which corresponds to the trigger condition 2 in Table 1, the target UE may apply the PPW/PPWRP values provided in the Table 1 for the corresponding trigger condition 2 after receiving acknowledgement from network.

In some example embodiments, if the measurement sample received in the PPW from at least ‘n’ number of anchor UEs have good signal strength, which corresponds to the trigger condition 3 in Table 1, the target UE may dynamically reduce the PPW, e.g., based on the preconfigured values received from gNB/LMF. Additionally or alternatively, the target UE may report lower number of anchor UEs (above the signal strength threshold) and does not need to wait for the measurement sample from the remaining anchor UEs. Thereby, the measurement and/or processing overhead at target UE may be reduced or avoided.

In some further example embodiments, if the measurement sample received in the PPW from at least ‘n’ number of anchor UEs has the signal strength less than the threshold, i.e., the signal strength has degraded, which corresponds to the trigger condition 4 in Table 1, the target UE may dynamically increase the PPW, e.g., based on the preconfigured values received from gNB/LMF. Additionally or alternatively, the target UE may report the higher number of anchor UEs so that a greater number of measurement samples from other anchor UEs can be received. Thereby, the measurement accuracy may be improved in cases where the PRS signal strength is weak.

In addition, the target UE may be provided with a list of anchor UEs and the level of importance (e.g., high, low) for each anchor UE in the positioning of the target UE. In such a case, the positioning support (i.e., SL PRS transmission) from an anchor UE with higher level of importance contributes higher in accuracy performance of the target UE. If the target UE has already performed measurements for SL PRS transmitted from the anchor UEs of high importance, which corresponds to the trigger condition 5 in Table 1, the target UE may not wait for measurement samples from the remaining anchor UEs.

For ease of understanding, the example behaviors of the target UE, the network (e.g., server UE or LMF), and the anchor UE/RSU in accordance with some example embodiments of the present disclosure will be described separately here with reference to the above Table 1.

In a case that any of the trigger conditions in the Table 1 is met, the target UE may indicate to the network that the trigger condition is met along with the trigger ID for modifying the PPW/PPWRP configuration as per the Table 1. In addition, the target UE may apply PPW/PPWRP for the corresponding trigger condition if an acknowledgement is received from the network. Furthermore, if configured by the network, the target UE may indicate the updated PPW/PPWRP configurations to road side units (RSUs) and/or anchor UEs.

Upon receiving the request for configuring the dynamic PRS configuration along with the trigger ID (as per the trigger conditions listed in the Table 1) from the target UE, the network may acknowledge to the UE by accepting the configuration. Moreover, the network may indicate to the anchor UEs regarding the updated PRS transmission configuration. Alternatively, the network may reject the dynamic configuration request from the target UE if the network cannot support the modification or if it receives reject message from any of the anchor UEs. The network may also notify the rejection to the target UE.

Upon receiving the request for configuring the dynamic PRS configuration from the network or the target UE, the RSUs or anchor UEs may align the PRS transmission based on the received PPW and PPWRP. Alternatively, the RSUs or anchor UEs may reject the received configuration and notify the network.

It should be understood that the solutions according to some example embodiments of the present disclosure may be also applicable for the legacy positioning where the anchor UE may be replaced with the transmission and reception point (TRP). The scope of the present disclosure is not limited in this respect.

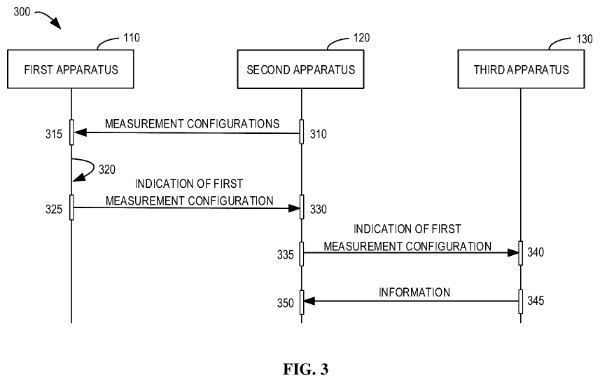

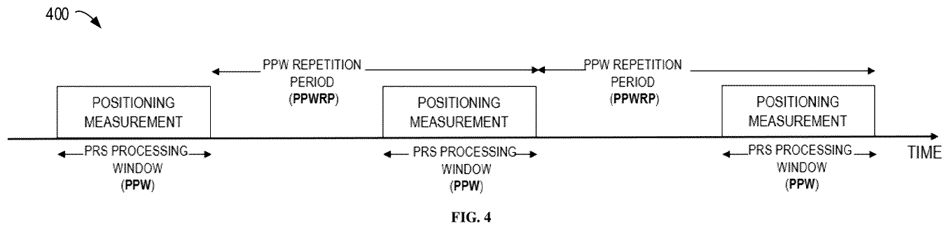

FIG. 5 is a schematic diagram 500 illustrating an example PRS configuration for a stationary target UE. In the example PRS configuration shown in FIG. 5, the PPW is 10 ms and the PPWRP is 200 ms. The dynamic configuration may be applied by the target UE based on the predefined trigger conditions as per the table received from the network, such as LMF or server UE. FIG. 6 is a schematic diagram 600 illustrating an example PRS configuration for a fast-moving target UE. As shown in FIG. 6 the PRS configuration may be dynamically modified.

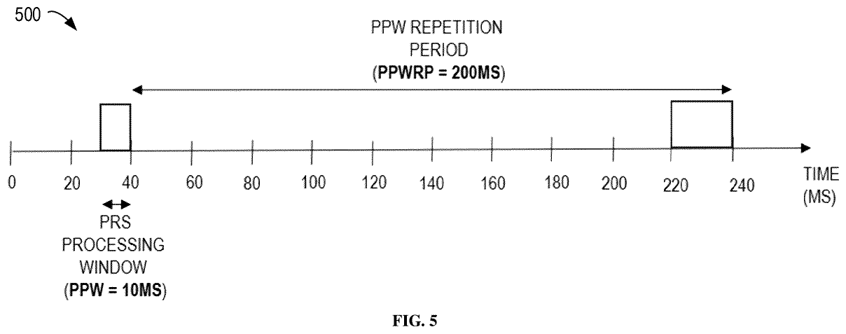

FIG. 7 illustrates a signaling chart 700 for dynamic configuration of measurement parameters for sidelink positioning according to some example embodiments of the present disclosure. In FIG. 7, the target UE 701 may be an example implementation of the first apparatus 110 in FIG. 1. The network 702 may comprise an LMF or a server UE, and may be an example implementation of the second apparatus 120 in FIG. 1. Moreover, the anchor UE 703 may be an example implementation of the third apparatus 130 in FIG. 1.

At 710, the network 702 may transmit sidelink (SL) measurement configuration along with the table for dynamic SL configuration to the target UE 701. At 712, the network 702 may also transmit the SL Measurement configuration to the anchor UE 703. At 714, the target UE 701 may report PRS measurement to the network 702 based on the SL Measurement configuration. At 716, the target UE 701 may detect whether the status of the target UE 701 is changed. If the status is changed, the target UE 701 may determine dynamic SL configuration based on a configured table consisting of triggering conditions. At 718, the target UE 701 indicates the detected change in its status including a trigger ID to the network 702. At 720, the network 702 indicates modification of SL measurement configuration, e.g., PRS transmission configuration, to the anchor UE 703. At 722, the anchor UE 703 determines whether to accept or reject the request of SL measurement configuration modification. At 724, the anchor UE 703 may indicate the acceptance or rejection of the request of SL measurement configuration modification to the network 702.

At 726, the network 702 may also determine whether to accept or reject the request of SL measurement configuration modification. By way of example, if the anchor UE 703 has rejected the SL configuration modification, or if there are constraints within the network 702 (such as, stringent data TX/RX requirements, anchor UE 703 reselection ongoing, etc.), the network 702 may reject the request of SL measurement configuration modification. Otherwise, the network 702 may accept the request of SL measurement configuration modification.

At 728, the network 702 may indicate the acceptance or rejection of the request of SL measurement configuration modification to the target UE 701. In some example embodiments, at 730, if the request of SL measurement configuration modification is accepted, the target UE 701 may indicate the updated SL configuration (if instructed by the network 702) to the anchor UE 703. At 732, the anchor UE 703 may determine whether to accept the request or not. At 734, the network 702 may indicate the acceptance or rejection of the request of SL measurement configuration modification to the target UE 701. At 736, if the request is accepted by the network 702 and anchor UE 703, the target UE 701 may apply SE configuration with corresponding trigger condition from the able. Alternatively, the target UE 701 may apply SE configuration with corresponding trigger condition from the able dependent on the network 702 configuration.

In view of the above, the proposed solutions can advantageously dynamically configurate the measurement parameters for sidelink positioning. Thereby, the positioning accuracy can be improved and the measurement errors and/or measurement overhead can be reduced or avoided.

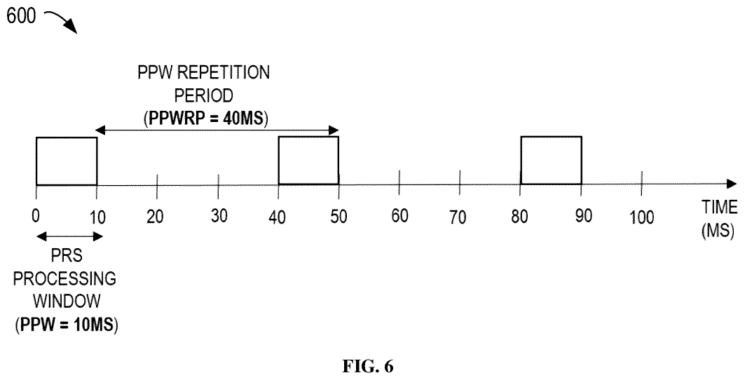

FIG. 8 shows a flowchart of an example method 800 implemented at a first apparatus in accordance with some example embodiments of the present disclosure. For the purpose of discussion, the method 800 will be described from the perspective of the first apparatus 110 in FIG. 1.

At block 810, the first apparatus 110 receives, from a second apparatus, a plurality of measurement configurations for sidelink positioning.

At block 820, in accordance with a determination that a first trigger condition defined the plurality of measurement configurations is met, the first apparatus 110 determines a first measurement configuration corresponding to the first trigger condition from the plurality of measurement configurations.

In some example embodiments, the method 800 further comprises: determining whether the first trigger condition is met based on at least one of: mobility information of the first apparatus, signal strength information of received sidelink reference signals, or importance information of third apparatuses transmitting the sidelink reference signals for the sidelink positioning.

In some example embodiments, the mobility information comprises at least one of: a velocity of the first apparatus, or a relative velocity between the first apparatus and a third apparatus transmitting a sidelink reference signals for the sidelink positioning.

In some example embodiments, the signal strength information comprises at least one of: signaling strength of respective sidelink reference signals transmitted from the third apparatuses, a first number of third apparatuses, each of which transmits a sidelink reference signal whose signal strength is above a first threshold strength, or a second number of third apparatuses, each of which transmits a sidelink reference signal whose signal strength is below a second threshold strength.

In some example embodiments, the method 800 further comprises: in accordance with a determination that measurement of the sidelink reference signals is performed for a set of third apparatuses whose importance levels exceed an importance threshold, determine the first trigger condition is met.

In some example embodiments, the method 800 further comprises: transmitting an indication of the first measurement configuration to the second apparatus.

In some example embodiments, the method 800 further comprises: receiving, from the second apparatus, first information indicating whether the first measurement configuration is accepted to be used; and in accordance with a determination that first information indicates that the first measurement configuration is accepted to be used, applying the first measurement configuration.

In some example embodiments, the method 800 further comprises: receiving, from the second apparatus, first information indicating whether the first measurement configuration is accepted to be used; in accordance with a determination that first information indicates that the first measurement configuration is accepted to be used, transmitting an indication of the first measurement configuration to a third apparatus which transmits a sidelink reference signal for the sidelink positioning; receiving, from the third apparatus, second information indicating whether the first measurement configuration is accepted to be used; and in accordance with a determination that the second information indicates that the first measurement configuration is accepted to be used, applying the first measurement configuration.

In some example embodiments, each configuration of the plurality of measurement configurations comprises a trigger condition which corresponds to at least one of the following measurement parameters: a Positioning Reference Signal Processing Window, PPW, a Positioning Reference Signal Processing Window Repetition Period, PPWRP, or a minimum number of third apparatuses which transmit sidelink reference signals for the sidelink positioning.

In some example embodiments, the first apparatus comprises a target terminal device, the second apparatus comprises a server terminal device or a Location Management Function device, and the third apparatus comprises an anchor terminal device.

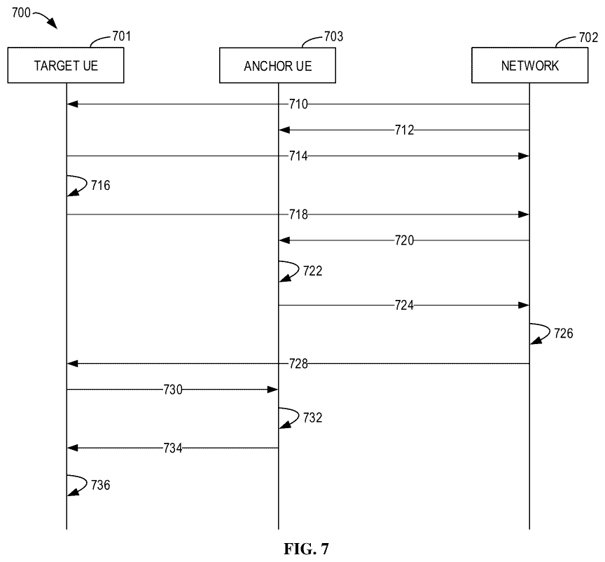

FIG. 9 shows a flowchart of an example method 900 implemented at a second apparatus in accordance with some example embodiments of the present disclosure. For the purpose of discussion, the method 900 will be described from the perspective of the second apparatus 120 in FIG. 1.

At block 910, the second apparatus 120 transmits, to a first apparatus, a plurality of measurement configurations of measurement parameters for sidelink positioning.

At block 920, the second apparatus 120 receives, from the first apparatus, an indication of a first measurement configuration. The first measurement configuration is determined from a plurality of measurement configurations for sidelink positioning in response to that a first trigger condition is met. The first trigger condition corresponds to the first measurement configuration and is defined in the plurality of measurement configurations.

In some example embodiments, the method 900 further comprises: determining whether the first apparatus is able to support the first measurement configuration based on at least one of: a data transmission requirement, an anchor reselection requirement, a mobility requirement, a signal strength requirement, or an anchor importance requirement; and in accordance with a determination that the first apparatus is unable to support the first measurement configuration, determining the first measurement configuration is rejected to be used.

In some example embodiments, the method 900 further comprises: transmitting an indication of the first measurement configuration to a third apparatus which transmits a sidelink reference signal for the sidelink positioning; and receiving, from the third apparatus, information indicating whether the first measurement configuration is accepted to be used; and in accordance with a determination that the information indicating that the first measurement configuration is not accepted to be used, determining the first measurement configuration is rejected to be used.

In some example embodiments, the method 900 further comprises: transmitting, to the first apparatus, first information indicating whether the first measurement configuration is accepted to be used.

In some example embodiments, each configuration of the plurality of measurement configurations comprises a trigger condition which corresponds to at least one of the following measurement parameters: a Positioning Reference Signal Processing Window, PPW, a Positioning Reference Signal Processing Window Repetition Period, PPWRP, or a minimum number of third apparatuses which transmit sidelink reference signals for the sidelink positioning.

In some example embodiments, the first apparatus comprises a target terminal device, the second apparatus comprises a server terminal device or a Location Management Function device, and the third apparatus comprises an anchor terminal device.

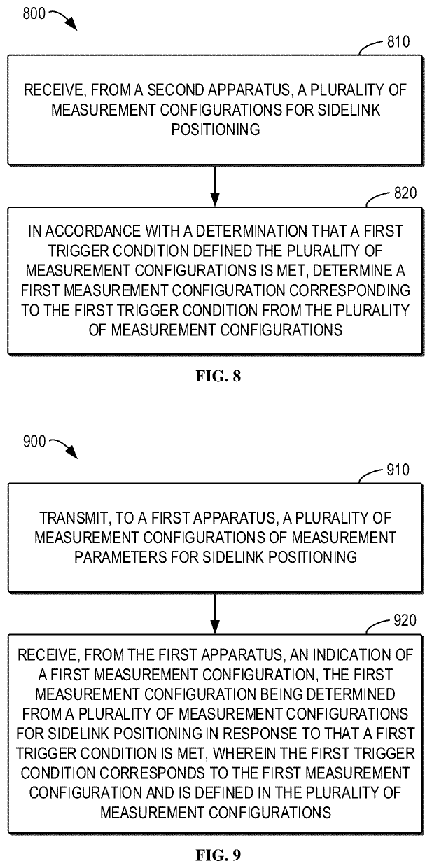

FIG. 10 shows a flowchart of an example method 1000 implemented at a third apparatus in accordance with some example embodiments of the present disclosure. For the purpose of discussion, the method 1000 will be described from the perspective of the third apparatus 130 in FIG. 1.

At block 1010, the third apparatus 130 receives, from a second apparatus, an indication of a first measurement configuration. The first measurement configuration is determined from a plurality of measurement configurations for sidelink positioning of a first apparatus in response to that a first trigger condition is met. The first trigger condition corresponds to the first measurement configuration and is defined in the plurality of measurement configurations; and

At block 1020, the third apparatus 130 transmits, to the second apparatus, information indicating whether the first measurement configuration is accepted to be used.

In some example embodiments, the method 1000 further comprises: receiving an indication of the first measurement configuration from a first apparatus; and transmitting, to the first apparatus, second information indicating whether the first measurement configuration is accepted to be used.

In some example embodiments, each configuration of the plurality of measurement configurations comprises a trigger condition which corresponds to at least one of the following measurement parameters: a Positioning Reference Signal Processing Window, PPW, a Positioning Reference Signal Processing Window Repetition Period, PPWRP, or a minimum number of third apparatuses which transmit sidelink reference signals for the sidelink positioning.

In some example embodiments, the method 1000 further comprises: in accordance with a determination that the first measurement configuration is accepted to be used, transmitting a sidelink reference signal for the sidelink positioning based on the first measurement configuration.

In some example embodiments, the first apparatus comprises a target terminal device, the second apparatus comprises a server terminal device or a Location Management Function device, and the third apparatus comprises an anchor terminal device.

### Example Apparatus, Device and Medium

In some example embodiments, a first apparatus capable of performing any of the method 800 (for example, the first apparatus 110 in FIG. 1) may comprise means for performing the respective operations of the method 800. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a plurality of measurement configurations for sidelink positioning; and means for in accordance with a determination that a first trigger condition defined the plurality of measurement configurations is met, determining a first measurement configuration corresponding to the first trigger condition from the plurality of measurement configurations.

In some example embodiments, the first apparatus further comprises: means for determining whether the first trigger condition is met based on at least one of: mobility information of the first apparatus, signal strength information of received sidelink reference signals, or importance information of third apparatuses transmitting the sidelink reference signals for the sidelink positioning.

In some example embodiments, the mobility information comprises at least one of: a velocity of the first apparatus, or a relative velocity between the first apparatus and a third apparatus transmitting a sidelink reference signals for the sidelink positioning.

In some example embodiments, the signal strength information comprises at least one of: means for signaling strength of respective sidelink reference signals transmitted from the third apparatuses, a first number of third apparatuses, each of which transmits a sidelink reference signal whose signal strength is above a first threshold strength, or a second number of third apparatuses, each of which transmits a sidelink reference signal whose signal strength is below a second threshold strength.

In some example embodiments, the first apparatus further comprises: means for in accordance with a determination that measurement of the sidelink reference signals is performed for a set of third apparatuses whose importance levels exceed an importance threshold, determine the first trigger condition is met.

In some example embodiments, the first apparatus further comprises: means for transmitting an indication of the first measurement configuration to the second apparatus.

In some example embodiments, the first apparatus further comprises: means for receiving, from the second apparatus, first information indicating whether the first measurement configuration is accepted to be used; and means for in accordance with a determination that first information indicates that the first measurement configuration is accepted to be used, applying the first measurement configuration.

In some example embodiments, the first apparatus further comprises: means for receiving, from the second apparatus, first information indicating whether the first measurement configuration is accepted to be used; means for in accordance with a determination that first information indicates that the first measurement configuration is accepted to be used, transmitting an indication of the first measurement configuration to a third apparatus which transmits a sidelink reference signal for the sidelink positioning; means for receiving, from the third apparatus, second information indicating whether the first measurement configuration is accepted to be used; and means for in accordance with a determination that the second information indicates that the first measurement configuration is accepted to be used, applying the first measurement configuration.

In some example embodiments, each configuration of the plurality of measurement configurations comprises a trigger condition which corresponds to at least one of the following measurement parameters: a Positioning Reference Signal Processing Window, PPW, means for a Positioning Reference Signal Processing Window Repetition Period, PPWRP, or a minimum number of third apparatuses which transmit sidelink reference signals for the sidelink positioning.

In some example embodiments, the first apparatus comprises a target terminal device, the second apparatus comprises a server terminal device or a Location Management Function device, and the third apparatus comprises an anchor terminal device.

In some example embodiments, the first apparatus further comprises means for performing other operations in some example embodiments of the method 800 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 900 (for example, the second apparatus 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a plurality of measurement configurations of measurement parameters for sidelink positioning; and means for receiving, from the first apparatus, an indication of a first measurement configuration, the first measurement configuration being determined from a plurality of measurement configurations for sidelink positioning in response to that a first trigger condition is met, wherein the first trigger condition corresponds to the first measurement configuration and is defined in the plurality of measurement configurations.

In some example embodiments, the second apparatus further comprises: means for determining whether the first apparatus is able to support the first measurement configuration based on at least one of: a data transmission requirement, an anchor reselection requirement, a mobility requirement, a signal strength requirement, or an anchor importance requirement; and means for in accordance with a determination that the first apparatus is unable to support the first measurement configuration, determining the first measurement configuration is rejected to be used.

In some example embodiments, the second apparatus further comprises: means for transmitting an indication of the first measurement configuration to a third apparatus which transmits a sidelink reference signal for the sidelink positioning; and means for receiving, from the third apparatus, information indicating whether the first measurement configuration is accepted to be used; and means for in accordance with a determination that the information indicating that the first measurement configuration is not accepted to be used, determining the first measurement configuration is rejected to be used.

In some example embodiments, the second apparatus further comprises: means for transmitting, to the first apparatus, first information indicating whether the first measurement configuration is accepted to be used.

In some example embodiments, each configuration of the plurality of measurement configurations comprises a trigger condition which corresponds to at least one of the following measurement parameters: a Positioning Reference Signal Processing Window, PPW, means for a Positioning Reference Signal Processing Window Repetition Period, PPWRP, or a minimum number of third apparatuses which transmit sidelink reference signals for the sidelink positioning.

In some example embodiments, the first apparatus comprises a target terminal device, the second apparatus comprises a server terminal device or a Location Management Function device, and the third apparatus comprises an anchor terminal device.

In some example embodiments, the second apparatus further comprises means for performing other operations in some example embodiments of the method 900 or the second apparatus 120. In some example embodiments, the means comprises at least one processor; and at least one memory storing instructions that, when executed by the at least one processor, cause the performance of the second apparatus.

In some example embodiments, a third apparatus capable of performing any of the method 1000 (for example, the third apparatus 130 in FIG. 1) may comprise means for performing the respective operations of the method 1000. The means may be implemented in any suitable form. For example, the means may be implemented in a circuitry or software module. The third apparatus may be implemented as or included in the third apparatus 130 in FIG. 1.

In some example embodiments, the third apparatus comprises means for receiving, from a second apparatus, an indication of a first measurement configuration, the first measurement configuration being determined from a plurality of measurement configurations for sidelink positioning of a first apparatus in response to that a first trigger condition is met, wherein the first trigger condition corresponds to the first measurement configuration and is defined in the plurality of measurement configurations; and means for transmitting, to the second apparatus, information indicating whether the first measurement configuration is accepted to be used.

In some example embodiments, the third apparatus further comprises: means for receiving an indication of the first measurement configuration from a first apparatus; and means for transmitting, to the first apparatus, second information indicating whether the first measurement configuration is accepted to be used.

In some example embodiments, each configuration of the plurality of measurement configurations comprises a trigger condition which corresponds to at least one of the following measurement parameters: a Positioning Reference Signal Processing Window, PPW, means for a Positioning Reference Signal Processing Window Repetition Period, PPWRP, or a minimum number of third apparatuses which transmit sidelink reference signals for the sidelink positioning.

In some example embodiments, the third apparatus further comprises: means for in accordance with a determination that the first measurement configuration is accepted to be used, transmitting a sidelink reference signal for the sidelink positioning based on the first measurement configuration.

In some example embodiments, the first apparatus comprises a target terminal device, the second apparatus comprises a server terminal device or a Location Management Function device, and the third apparatus comprises an anchor terminal device.

In some example embodiments, the third apparatus further comprises means for performing other operations in some example embodiments of the method 1000 or the third apparatus 130. In some example embodiments, the means comprises at least one processor; and at least one memory storing instructions that, when executed by the at least one processor, cause the performance of the third apparatus.

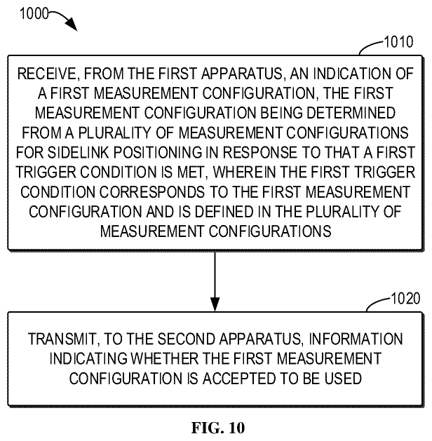

FIG. 11 is a simplified block diagram of a device 1100 that is suitable for implementing example embodiments of the present disclosure. The device 1100 may be provided to implement a communication device, for example, the first apparatus 110, the second apparatus 120, or the third apparatus 130 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The instructions of the program 1130 may include instructions for performing operations/acts of some example embodiments of the present disclosure. The program 1130 may be stored in the memory, e.g., the ROM 1124. The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIG. 3 to FIG. 10. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

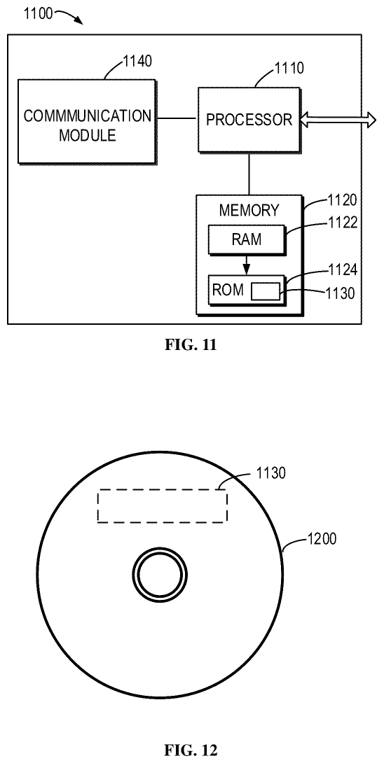

FIG. 12 shows an example of the computer readable medium 1200 which may be in form of CD, DVD or other optical storage disk. The computer readable medium 1200 has the program 1130 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, a plurality of measurement configurations for sidelink positioning; and
in accordance with a determination that a first trigger condition defined the plurality of measurement configurations is met, determine a first measurement configuration corresponding to the first trigger condition from the plurality of measurement configurations.

2. The first apparatus of claim 1, wherein the first apparatus is caused to:
determine whether the first trigger condition is met based on at least one of: mobility information of the first apparatus, signal strength information of received sidelink reference signals, or importance information of third apparatuses transmitting the sidelink reference signals for the sidelink positioning.

3. The first apparatus of claim 2, wherein the mobility information comprises at least one of:
a velocity of the first apparatus, or
a relative velocity between the first apparatus and a third apparatus transmitting a sidelink reference signals for the sidelink positioning.

4. The first apparatus of claim 2, wherein the signal strength information comprises at least one of:
signal strength of respective sidelink reference signals transmitted from the third apparatuses,
a first number of third apparatuses, each of which transmits a sidelink reference signal whose signal strength is above a first threshold strength, or
a second number of third apparatuses, each of which transmits a sidelink reference signal whose signal strength is below a second threshold strength.

5. The first apparatus of claim 2, wherein the first apparatus is caused to:
in accordance with a determination that measurement of the sidelink reference signals is performed for a set of third apparatuses whose importance levels exceed an importance threshold, determine the first trigger condition is met.

6. The first apparatus of claim 1, wherein the first apparatus is caused to:
transmit an indication of the first measurement configuration to the second apparatus.

7. The first apparatus of claim 1, wherein the first apparatus is caused to:
receive, from the second apparatus, first information indicating whether the first measurement configuration is accepted to be used; and
in accordance with a determination that first information indicates that the first measurement configuration is accepted to be used, apply the first measurement configuration.

8. The first apparatus of claim 1, wherein the first apparatus is caused to:
receive, from the second apparatus, first information indicating whether the first measurement configuration is accepted to be used;
in accordance with a determination that first information indicates that the first measurement configuration is accepted to be used, transmit an indication of the first measurement configuration to a third apparatus which transmits a sidelink reference signal for the sidelink positioning;
receive, from the third apparatus, second information indicating whether the first measurement configuration is accepted to be used; and
in accordance with a determination that the second information indicates that the first measurement configuration is accepted to be used, apply the first measurement configuration.

9. The first apparatus of claim 1, wherein each configuration of the plurality of measurement configurations comprises a trigger condition which corresponds to at least one of the following measurement parameters:
a Positioning Reference Signal Processing Window,
a Positioning Reference Signal Processing Window Repetition Period, or
a minimum number of third apparatuses which transmit sidelink reference signals for the sidelink positioning.

10. The first apparatus of claim 1, wherein the first apparatus comprises a target terminal device, the second apparatus comprises a server terminal device or a Location Management Function device, and the third apparatus comprises an anchor terminal device.

11. A second apparatus comprising:
at least one processor; and
at least one memory storing instructions that, when executed by the at least one processor, cause the second apparatus at least to:
transmit, to a first apparatus, a plurality of measurement configurations of measurement parameters for sidelink positioning; and
receive, from the first apparatus, an indication of a first measurement configuration, the first measurement configuration being determined from a plurality of measurement configurations for sidelink positioning in response to that a first trigger condition is met, wherein the first trigger condition corresponds to the first measurement configuration and is defined in the plurality of measurement configurations.

12. The second apparatus of claim 11, wherein the second apparatus is caused to:
determine whether the first apparatus is able to support the first measurement configuration based on at least one of: a data transmission requirement, an anchor reselection requirement, a mobility requirement, a signal strength requirement, or an anchor importance requirement; and
in accordance with a determination that the first apparatus is unable to support the first measurement configuration, determine the first measurement configuration is rejected to be used.

13. The second apparatus of claim 11, wherein the second apparatus is caused to:
transmit an indication of the first measurement configuration to a third apparatus which transmits a sidelink reference signal for the sidelink positioning; and
receive, from the third apparatus, information indicating whether the first measurement configuration is accepted to be used; and
in accordance with a determination that the information indicating that the first measurement configuration is not accepted to be used, determine the first measurement configuration is rejected to be used.

14. The second apparatus of claim 11, wherein the second apparatus is caused to:
transmit, to the first apparatus, first information indicating whether the first measurement configuration is accepted to be used.

15. The second apparatus of claim 11, wherein each configuration of the plurality of measurement configurations comprises a trigger condition which corresponds to at least one of the following measurement parameters:
a Positioning Reference Signal Processing Window,
a Positioning Reference Signal Processing Window Repetition Period, or
a minimum number of third apparatuses which transmit sidelink reference signals for the sidelink positioning.

16. The second apparatus of claim 11, wherein the first apparatus comprises a target terminal device, the second apparatus comprises a server terminal device or a Location Management Function device, and the third apparatus comprises an anchor terminal device.

17. A third apparatus comprising:
at least one processor; and
at least one memory storing instructions that, when executed by the at least one processor, cause the third apparatus at least to:
receive, from a second apparatus, an indication of a first measurement configuration, the first measurement configuration being determined from a plurality of measurement configurations for sidelink positioning of a first apparatus in response to that a first trigger condition is met, wherein the first trigger condition corresponds to the first measurement configuration and is defined in the plurality of measurement configurations; and
transmit, to the second apparatus, information indicating whether the first measurement configuration is accepted to be used.

18. The third apparatus of claim 17, wherein the third apparatus is caused to:
receive an indication of the first measurement configuration from a first apparatus; and
transmit, to the first apparatus, second information indicating whether the first measurement configuration is accepted to be used.

19. The third apparatus of claim 17, wherein each configuration of the plurality of measurement configurations comprises a trigger condition which corresponds to at least one of the following measurement parameters:
a Positioning Reference Signal Processing Window,
a Positioning Reference Signal Processing Window Repetition Period, or
a minimum number of third apparatuses which transmit sidelink reference signals for the sidelink positioning.

20. The third apparatus of claim 17, wherein the third apparatus is caused to:
in accordance with a determination that the first measurement configuration is accepted to be used, transmit a sidelink reference signal for the sidelink positioning based on the first measurement configuration.
